(19) United States
(12) Patent Application Publication
(10) Pub. No.: US 2008/0109378 A1
(43) Pub. Date: May 8, 2008

(54) Financial product frequent identification and comparision service

(76) Inventor: Odiseas Papadimitriou, Arlington, VA (US)

Correspondence Address: MOAZZAM & ASSOCIATES, LLC, 7601 LEWINSVILLE ROAD, SUITE 304, MCLEAN, VA, 22102, US

(21) Appl. No.: 11/544,859

(22) Filed: Oct. 10, 2006

(51) Int. Cl. G06Q 40/00

(52) U.S. Cl. 705/36 R

(57) ABSTRACT

Systems and methods for identifying and comparing financial products on a regular basis are disclosed. Client information is collected, validated, and stored in a data warehouse and kept up to date. Client information is periodically transmitted to decisionmaking components and information about financial products for which the client is eligible is received. The system comprehensively compares the received financial products and determines which of them, if any, is best for the client. The system transmits the chosen financial products to the client. If the client decides to obtain one of the financial products, the system facilitates the process of obtaining the financial product.

### BACKGROUND OF THE INVENTION

1. Field of the Invention

The present invention relates to a comparison service for financial products. More particularly, the present invention relates to techniques for regularly identifying and comparing financial products, and simplifying the process of transferring from one product to another.

2. Background of the Invention

Financing is an important aspect of modern life. The overwhelming majority of consumers finance large purchases (such as automobiles or houses) through the use of loans or mortgages. Similarly, life insurance and health insurance are becoming more essential as the baby boomer population increases, and medical costs rise. In addition, certain types of insurance, such as automobile insurance, are not only essential but also mandatory.

The advent of electronic communications and the Internet has, in some respects, simplified the job of searching for suitable financial products, such as loans, insurance policies, and credit cards. Consumers can search the Internet to find the latest loan offers, insurance plans, and credit cards, they can research the various plans available and they can decide which one is most suitable for them.

Some companies have begun to automate the process of identifying financial products. Consumers looking for a loan or seeking to refinance or otherwise manage their debt can access a web page. The consumers enter their information into the web page. The company then uses this information to search available loans and display selected loans to the consumer. These loans would be loans that the consumer is qualified to get (based on a credit score or other information).

However, the existing systems for providing financial services have a number of drawbacks. Existing systems cater only to consumers actively looking to get a new financial product (i.e., shopping around). In other words, they do not meet the consumer's ongoing needs after the consumer interacts with the system. Frequent use of the existing systems for lending products can hurt a consumer's credit score by posting multiple “credit inquiries” to their credit bureau. Furthermore, existing services do not provide comprehensive comparisons between the products for which the client is eligible. In addition, most existing processes for transferring the consumer from one product to another are unnecessarily costly, time consuming and cumbersome. Lastly, some systems only search for financial products offered by the financial institution implementing the system.

Existing systems do not meet the consumer's ongoing needs after the consumer interacts with the system because they only provide a snapshot of what is available at the time the consumer enters his information. With existing systems, a consumer enters information and receives a list of products for which the consumer is eligible at that point in time. However, the following non-limiting examples of changes impact which financial products are best for the consumer over time: changes in the economic environment (e.g., interest rates), changes in products and eligibility guidelines offered by financial institutions, changes in economic status (e.g., salary increase, sending children to college, etc.), and changes in credit scores. Existing systems do not provide the needed visibility into how these ongoing changes can be addressed. A consumer can enter information on one day and not become aware of a better product a week later.

To be specific, even a small increase in a consumer's credit rating can result in a large difference in the financial products the consumer is offered. Thus, a consumer who uses an existing system to get a loan at an 8% interest rate will not receive notification from existing systems when an increase in his credit score would qualify him for a loan at a 6% interest rate. In another example, a consumer's own needs and goals may change over time. A consumer might get a mortgage that minimizes the amount of interest she pays. Two years later, her primary goal becomes minimizing her monthly mortgage payment in order to fund her child's college tuition, even if that means paying a higher interest rate. With existing systems the consumer would have to re-apply with a number of financial institutions in order to determine by how much she can have her monthly payment lowered. If she does not find something that meets her needs at that time, she will have to repeat the same process on a periodic basis. Repeating this process is not only extremely time consuming, but will most likely negatively impact her credit score given the multiple “credit inquiries” posted by each financial institution on her credit report.

The comparisons performed by existing systems are also not comprehensive for at least three main reasons. First, they do not “cut through” the fine print to compare the products along multiple product terms (e.g., fees, switching costs, liability coverage, etc.), but instead seem to compare by utilizing only one product term (e.g., interest rate for lending and savings products or premium amount for insurance products). Second, they do not take into account the client's needs, goals, and expected usage when performing the comparisons. Third, they do not compare the identified products to the client's existing financial product, if any. Other reasons are also possible and evident to one having ordinary skill in the art.

The lack of a system that continuously identifies the financial products for which a consumer qualifies and constantly performs a comprehensive evaluation of how these products meet the consumer's individual situation, has resulted in an environment where consumers are left for long periods of time with worse products that cost more and/or offer less. Even if the consumer goes through the inconvenience of regularly checking and applying for financial products, these repeated requests for a credit report from financial institutions can lower the consumer's credit score and limit the consumer's access to competitive financial products.

What is needed is a system that regularly seeks suitable financial products for which the client is eligible, performs a comprehensive comparison of these products, and recommends the best product for each client relative to both their needs and existing financial products, if any. This system needs to do all of the above without negatively impacting the consumer's credit score. Once the consumer decides to switch financial products, the system needs not only to assist the consumer with the process but also to simplify it such that it is less time consuming, costly, and cumbersome.

### SUMMARY OF THE INVENTION

Existing systems for assisting consumers in searching and obtaining financial products suffer from a number of drawbacks. Existing systems cater only to consumers actively seeking a new financial product (e.g., shopping around). In other words, they do not meet the consumer's ongoing needs after the consumer interacts with the system. A consumer has no way of knowing whether changes in the economic environment (e.g., interest rates), changes in products and eligibility guidelines offered by financial institutions, changes in their economic status (e.g., salary increase, sending children to college, etc.), and changes in their credit scores might result in a better offer. A consumer can enter information on one day and not become aware of a better product a week later. Frequent use of the existing systems for lending products can hurt a consumer's credit score by posting multiple “credit inquiries” to their credit bureau. Furthermore, existing services do not provide comprehensive comparisons both between the products for which the client is eligible for and relative to their existing products, if any. In addition, most existing processes for transferring the consumer from one product to another are unnecessarily costly, time consuming and cumbersome. Lastly, some systems only search for financial products offered by the financial institution implementing the system. The present invention addresses these problems and others common in the marketplace by providing consumers with a unique and powerful tool to automatically and continuously seek suitable financial products for which the client is eligible, perform a comprehensive comparison of these products, and recommend the best product for each client relative to both their needs and existing financial products, if any. This tool does all of the above without negatively impacting the consumer's credit score. Once the consumer decides to switch financial products, the tool not only assists the consumer with the process but also simplifies it such that it is less time consuming, costly, and cumbersome.

In one exemplary embodiment, the present invention is a system for regularly comparing and obtaining financial product information. The system includes a plurality of components. A data warehouse component stores client information. A client data collection component collects client information and storing the information in the data warehouse component. A decisionmaking component receives client information and transmits financial product information based on the client information. A communication component communicates client information stored in the data warehouse component to the decisionmaking component and receives financial product information from the decisionmaking component. A product comparison component compares a plurality of financial product information received by the communication component and transmits a subset of the plurality of financial product information to the client based on the comparison. A transfer facilitation component facilitates the client's transfer from one financial product to another financial product.

In another exemplary embodiment, the present invention is a method for regularly comparing financial products. Client information is collected and stored in a data warehouse. Client information stored in the warehouse is communicated to decisionmaking components. Financial product information is received from the decisionmaking components. These financial products are compared and a subset is transmitted to the client. These steps may be performed on a regular basis.

### BRIEF DESCRIPTION OF THE DRAWINGS

FIG. 1 shows an overview of an environment in which various exemplary embodiments of the present invention may operate.

FIG. 2 shows an overview of a system according to an exemplary embodiment of the present invention.

FIG. 3 shows a method of operating various exemplary embodiments of the present invention.

FIG. 4 is a continuation of the method shown in FIG. 3.

FIG. 5 is the continuation of the method shown in FIG. 3 and FIG. 4.

FIG. 6 shows examples of client information which may be collected according to various exemplary embodiments of the present invention.

### DETAILED DESCRIPTION OF THE INVENTION

The present invention provides a system to assist clients in regularly finding and comparing financial products they qualify for without affecting their credit rating and without the need to re-apply constantly. The system may then assist and simplify the existing processes of transferring from an existing financial product (if any) to a new financial product. The present invention may be deployed in any environment and may be used to compare financial products of any type. Clients could access the system through a web page via the Internet. A financial institution could also provide the present invention as an additional service to clients; the financial institution can market the system as a way of looking out for the client's interests by showing competing financial products and assisting the client in switching to a competitors product if that product proves a better match for the client. These environments are exemplary and non-limiting; the system could be operated in any environment.

The present invention may be used to compare any type of financial product. Financial products could include, for example, lending products, insurance products, savings products, and investment products. Lending products include mortgages, automobile loans, student loans, personal loans, home equity lines of credit (HELOC's), credit cards, and debit cards. Insurance products include all forms of insurance, including home insurance, automobile insurance, life insurance, health insurance, or renters insurance. Savings products include services such as savings accounts, certificates of deposits, or money market accounts. Investment products include investment accounts, such as mutual funds. The present invention may be used to compare these or any other type of product.

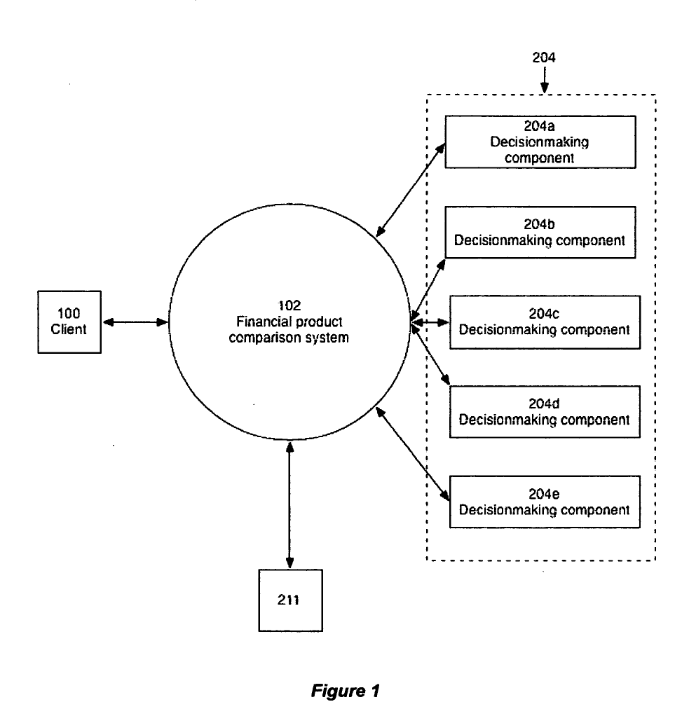

FIG. 1 shows an environment in which the present invention may operate. Client 100, who may be an individual, corporation, or other entity, communicates with financial product system 102. Here and throughout this disclosure, the term “client” is also intended to be used interchangeably with the term “consumer”. Financial product system 102 collects data about the client 100 from both the client 100 and a number of other data sources 211 so that financial product system 102 will use the information collected in evaluating financial products. Once financial product system 102 has collected sufficient information about client 100, financial product system 102 communicates the client information to decisionmaking components 204a, 204b, 204c, 204d, and 204e (collectively referred to as decisionmaking components 204). The financial product system may communicate client information to any number of decisionmaking components. The decisionmaking components may be in a variety of locations. For example, in FIG. 1 decisionmaking component 204a is located at a financial institution, such as a bank, insurance company, or credit card company. Decisionmaking components 204b and 204c are “in-house,” the same location as financial product system 102. Decisionmaking components 204d and 204e are at a third party. The number of decisionmaking components and their locations are exemplary; there may be any number of decisionmaking components at any location.

The financial product system 102 can collect any type of client information about client 100. The client information may be any information helpful to decisionmaking components 204 in evaluating client 100. For example, client information can include personal information such as client 100's name and address. Financial product system 102 may also collect information about any existing products client 100 is using, such as existing loans, insurance policies, checking/savings accounts, or investment accounts. Client 100 may also supply information about their own preferences, such as a preferred interest rate, insurance coverage, or credit limit. Clients may supply financial product system 102 with information about their needs or goals, such as “low monthly payment” or “higher liability coverage.” Financial product system 102 may derive client needs from client information already collected. Financial product system 102 could also collect or receive information about the client 100 from a number of different sources 211 (such as credit bureaus).

The decisionmaking components 204 use the client information provided by the financial product system to evaluate the client 100 and determine the financial products to offer the client 100. Once the decisionmaking components determine which financial products they wish to offer client 100, the decisionmaking components transmit information on these products to financial product system 102. Financial product system 102 evaluates and compares the products it has received from the decisionmaking components 204. This evaluation is a comprehensive comparison taking into account a variety of factors. The comparison compares new financial products not only between themselves but also between the new financial products and client's existing product, if any. If the financial product system 102 determines that one or more of the new financial products provides the client 100 with the best opportunity, financial product system 102 transmits information on the selected products to the client 100, depending on how the client wishes to be contacted. The client 100 may then evaluate the information himself. The financial product system is available to assist the client 100 should the client 100 choose to switch from an existing financial product to a financial product identified by financial product system 102.

The process described above occurs constantly and may occur in real time. Financial system 102 updates client information on a regular basis. The financial system transmits information to, and receives financial product information from, the decisionmaking components on a regular basis. As the financial product system 102 receives financial product information, it performs the comprehensive comparison and, depending on the client's preferences, transmits the information to the client. In this way the client will always have access to the most up-to-date and competitive financial products. The system can operate in real time, collecting client information, consulting with decisionmaking components, and comparing financial products while the client is still interacting with the system. The system can also operate continually over a period of time, with the system periodically collecting information about the client, then later consulting decisionmaking components and comparing financial products.

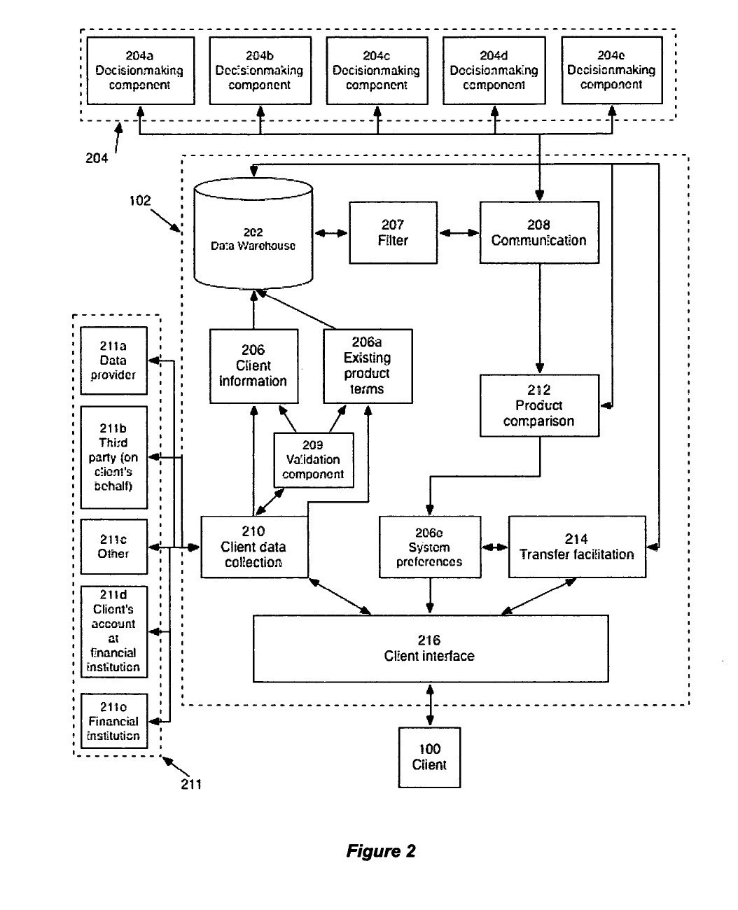

FIG. 2 shows an exemplary embodiment of the present invention. Financial product system 102, shown in dotted lines, contains a number of components. Financial product system 102 interacts with client 100 via client interface 216. Client interface 216 receives information from and transmits information to client 100. Client interface 216 could, for example, be a website. Client 100 may have an account on the website and can log in to the account to enter (or update) client information into the financial product system 102, receive information about financial products identified by the financial product system as competitive offers, and transact any other business with financial product system 102. In addition to a website, client interface 216 could also have an electronic mail capability wherein the client interface 216 can send electronic mail to client 100 alerting the client to new financial products.

Client data collection component 210 collects client information 206, which may include existing product terms 206a. Client data collection component collects client information 206 in a number of ways. An important source of information about the client 100 is the client 100 himself. Client 100 may log in to the financial product system 102 via client interface 216 and provide information to client data collection 102. Client data collection component may also collect client information 206 from other sources such as financial institutions, credit bureaus, and third parties.

Client data collection component 210 may collect data from sources 211 other than the client in a variety of fashions. Client data collection component 210 could log in (with client 100's approval) to a client 100's existing account with a financial institution or other organization and download client information, as shown by box 211d. Client 100 could give a financial institution permission to transmit directly client information to client data collection component 210, shown by box 211e. A third party may also enter client information 206 on client 100's behalf, shown by box 211b. For example, an automobile dealership could enter information about client 100's automobile loan. Client data collection component may collect information from a data provider, such as a credit bureau, shown by box 211a. Client data collection component 210 may use these or any other source (box 211c) or technique for collecting client information 206.

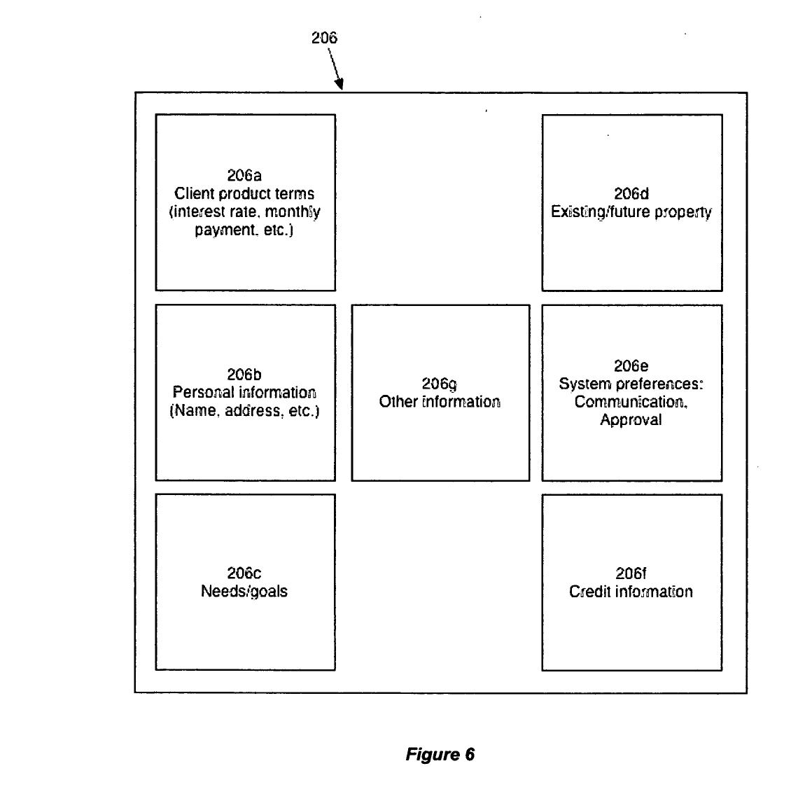

Client information 206 may include any information about the client. FIG. 6 shows some classes of client information. Client information may include information 206a about the client's existing financial product (if any), such as interest rate, liability coverage, credit limit, or monthly payment. Client information 206 also includes personal information 206b, such as the client's name, address, and telephone number. Client information 206 may also include information 206c about the client's needs and/or goals. These goals would depend on the particular financial product(s) the client 100 is looking for. For example, if client 100 is looking for automobile insurance, the client may need the highest liability coverage available. If the client is in the market for a new home, the client may be looking for a $500,000 mortgage with a low monthly payment for the first two years of the mortgage. If the client is looking for both automobile insurance and a mortgage, information 206c would include the client's needs and/or goals for both. Client information 206 may also include information 206d about the client's existing or future property. For example, if the client is looking to monitor a mortgage for their existing home, information 206d would be information about the client 100's existing home. If the client instead were looking for a new home, information 206d would be information about the new home. If the client were looking both to monitor an existing mortgage and for a new home (for example a vacation or summer home), information 206d would include information about both the client's existing home and the client's new home. Client information also includes the client's system preferences 206e. System preferences may include, among others, the client's preferred schedule or criteria for transmitting client information 206 to decisionmaking components; the preferred schedule for communicating financial product information back to client 100; and criteria for automatically approving a transfer to a new financial product. Credit information 206f includes information about the client's credit. This may include the client's credit report and/or credit score. Client information may include other information 206g which may be useful to financial product system 102. Information 206a, 206b, 206c, 206d, 206e, 206f are examples of the information included in client information 206. Client information 206 includes all the information financial product system 102 would need to obtain competitive financial products for client 100 and/or perform the comprehensive comparison.

Returning to FIG. 2, Client data collection component 210 continues to collect and update client information 206 about client 100 over the course of client 100's association with the financial product system 102, using the techniques and sources described above. Collecting up-to-date client information on a regular basis gives financial product system 102 an accurate and current picture of client 100's situation. In turn, financial product system 102 can retrieve financial products based on the client's current information, not on outdated information. For example, client data collection component 210 may obtain a credit report or credit score for client 100 on a regular basis. Most of these credit reports would be obtained as part of credit monitoring. “Monitoring inquiries” do not negatively impact the client's credit score. However, standard “credit inquiries” may negatively impact a client's credit report if a number of them are done in a short time period. Financial system thus has frequent access to the client's most recent credit report or credit score while still preserving the client's good credit. An improved credit score will result in the client receiving more competitive financial products than the client otherwise would have received (in the event that the client's credit score improved over time). In this fashion financial product system 102 presents the client with competitive financial products tailored to client 100's current situation.

Client data collection component 210 may transmit client information 206 it has collected to a validation component 209 prior to storing client information 206 in data warehouse 202. Validation component validates client information 206 to make sure that the client information is accurate and no information is missing. For example, if validation component discovers that the client's name is missing or the address is incomplete, or certain required financial data is still needed, validation component may communicate with client data collection component, requesting correct or completed information. Validation component 209 is optional; client data collection component may store client information 206 in data warehouse 202 without going through validation component 209.

Client data collection component 210 stores client information 206 in data warehouse 202. Data warehouse 202 contains information about all clients using financial product system 102. Client data collection component 210 updates client information 206 stored in data warehouse 202 as needed. The client 100 may also log into the financial product system 102 at a later date and provide updated information to client data collection component 102. Data warehouse component 202 may store any information useful to financial product system 102. Data warehouse component could, for example, store information about financial products received from decisionmaking components 204.

Communication component 208 transmits client information stored in data warehouse 202 to decisionmaking components 204. This transmitting occurs on a regular basis, which may be determined by filter 207. Filter 207 contains guidelines to determine what client information communication component 208 should send to decisionmaking components 204. Filter 207 may use the client's own preferences to determine when to transmit client information to decisionmaking components 204. The client may, for example, specify that the system should transmit client information on a weekly schedule. Filter 207 will then instruct communication component 208 to transmit client information 206 once a week. Filter 207 may also instruct communication component 208 to transmit client information when certain criteria are met, such as when market conditions change, the client's financial situation changes, or when the client's creditworthiness changes. For example, filter 207, possibly using information stored in data warehouse 202, may determine that automobile loan interest rates have been continually decreasing for all clients. In response, filter 207 instructs communication component 208 to transmit client 100's information 206 to see if client 100 will also receive a more competitive product than what the client currently has or was last quoted. In another example, filter 207 determines that due to the client's increased credit score, client 100 may be eligible for more competitive financial products. Communication component 208 transmits the updated client information 206 to decisionmaking components 204 so the client 100 can potentially receive financial products better suited for his needs. The predetermined schedule or criteria could be set by the client as part of system preferences 206e (shown in FIG. 6) or by the filter 207. These or any other criteria or schedule may be used by filter 207 to determine when to transmit client information 206.

Filter 207 may use the techniques and criteria described above to determine when communication component 208 should not transmit client information 206 to decisionmaking components 204. For example, if client 100 is looking for auto insurance, filter 207 will instruct communication component 208 not to transmit information about the client's home mortgage, since that information is not relevant when making decisions about auto insurance. Similarly, filter 207 may determine that the client is looking for a mortgage with the lowest possible interest rate. However, the client's current rate is 6% and the best rate available on the market today is 8%. Filter 207 can instruct communication component 208 not to transmit information about the client's mortgage since the client cannot receive a better rate than the client's current rate. In another example, filter 207 may determine that client 100's current credit score would not qualify client 100 for competitive products from particular financial institutions. Filter 207 can instruct communication component 208 not to transmit client information 206 to decisionmaking components representing financial institutions from which the client cannot receive a competitive offer. This reduces the amount of wasted effort spent by both the financial product system 102 and financial institutions, which may not want financial product system 102 to transmit information on clients ineligible for competitive products. Filter 207 may use these or any other criteria to determine what client information to send, where to send client information, and when to send the client information. Decisionmaking components 204a, 204b, 204c, 204d, 204e (collectively referred to as decisionmaking components 204) determine, based on client information, what financial products they are willing to offer client 100 and on what terms the financial institutions will offer these financial products. Each decisionmaking component 204a, 204b, 204c, 204d, 204e has access to financial product information for a particular financial institution or other entity, as well as the criteria for determining whether, and under what terms, a given client should be offered a given financial product. Decisionmaking components 204 may be stored in any location and may have a variety of criteria for evaluating client information 100. For example, decisionmaking component 204a is located at a financial institution, such as bank or insurance company. The financial institution may want to keep its evaluation criteria confidential and for this reason (or any other reason) decisionmaking component 204a is located at the financial institution. Decisionmaking component 204b is located in-house, under the control of the same entity operating the financial product system 102. The financial institution whose products decisionmaking component will offer also uses confidential criteria to evaluate clients. Because of a partnership or other arrangement, the financial institution is willing to allow decisionmaking component 204b to remain in-house and use the financial institution's confidential criteria to evaluate clients. Decisionmaking component 204c is also located in-house. However, decisionmaking component 204c uses criteria in the public domain to evaluate client information 100 and determine the appropriate product offerings. In the insurance industry, for example, insurance companies are required by law to publicly disclose the guidelines by which they underwrite policies. Decisionmaking component 204c uses these publicly available criteria to evaluate client information, instead of relying on the insurance companies themselves. Decisionmaking component 204d is located at a third party and uses confidential criteria from a financial institution in evaluating clients. Decisionmaking component 204e is also located at a third party, but uses public domain criteria in evaluating clients. There may be any number of decisionmaking components 204. Decisionmaking components may be located anywhere and may use any criteria in evaluating the financial products for which different clients are eligible.

If the decisionmaking component decides to offer a financial product to client 100, the decisionmaking component transmits information on the financial product being offered to communication component 208. The information about the financial product may include all the terms and details of the financial product being offered.

Periodic checking for new financial products provides benefits to both financial institutions and client 100. Financial institutions benefit from increased exposure to their financial products, enabling clients to see (over time) positive changes in the financial products clients are eligible for. Previously, financial institutions exposed prospective clients to new financial products using pre-screened offers or direct mailing. However, clients no longer respond favorably to direct mail. Further, legislation creating “opt-out” lists limits the effectiveness of pre-screened offers of credit. Even if the client reads the direct mail or chooses not to opt out, the financial offers the clients receive may be outdated by the time the clients receive the offers or decide to participate. In contrast, under the present system financial institutions can be certain the client is receiving the most current financial products tailored to the client's present circumstances.

An even more important problem than outdated information is the lack of access by financial institutions to all the relevant client information required to proactively make an accurate and specific offer for a financial product. For example, most financial institutions do not have access to the type of vehicle a client drives and therefore cannot proactively solicit the client with a firm and specific offer in regards to their vehicle insurance premium. With the present invention, participating financial institutions have access to all relevant client information, such as the type of automobile the client owns, the type of mortgage the client has (such as 30 year fixed, 5/1 ARM, etc.), or the client's credit line on the client's credit card(s).

The present invention resolves these and other problems for participating financial institutions. With the present invention, financial institutions can use all relevant client information to present prospective clients with financial products tailored to the client's current situation and needs, increasing the likelihood of the client signing up for the product. Through the periodic communication of up-to-date client information to decisionmaking components 204, participating financial institutions can rely on current and complete client information.

Clients also benefit from periodic requests for financial products. Changing factors in the financial industry result in a client receiving different offers depending on when the client applies for financial products. These factors include changing market environments (such as rising or falling interest rates), the client's creditworthiness, the client's financial situation (such as a new house or job), and the roll-out of new financial products, underwriting guidelines, and promotions. The periodic communication of client information from data warehouse 202 to decisionmaking components 204 enables the client to receive financial products reflecting the current environment, as opposed to offers reflecting a previous environment. The client receives customized offers without being required to request them himself. The client is assured of always having the best offers available, without hassle and without risking damage to their credit.

Product comparison component 212 receives financial product information from communication component 208 and comprehensively compares financial products to determine if client 100 can receive a better product than client 100's current financial product. Product comparison component 212 can compare products in at least three ways.

Product comparison component 212 may use a head to head comparison when comparing two products. In a head to head comparison, product comparison component compares two similar (or identical) products and determines which (if any) provide client 100 with the best price, or a better price than client 100's existing financial product. What constitutes the best price may vary from product to product. For example, price may refer to interest rate for lending and savings products or premium for insurance products. The client 100 may also identify, as part of the client information, what feature or features of financial products the product comparison component 212 should compare. In comparing financial products, product comparison component 212 may also take into account fixed costs. Fixed costs may include the cost of switching from one financial product to another, such as pre-payment penalties or closing costs. Other financial products may have different fixed costs. For example, when comparing credit card products, annual fees may be considered as fixed costs.

Product comparison component may use a needs-based comparison when comparing two financial products. In a needs based comparison, the product comparison component 212 compares financial products to determine which product most closely meets client 100's current needs. The client's current needs may be identified as part of the client information stored in data warehouse 202. Product comparison component may also determine the client's needs based on an analysis of the client information stored in data warehouse component 202. Each client may have different needs depending on the particular products the product comparison component 212 is comparing. For example, client 100 may need to have a home loan with the lowest monthly payment possible. Instead of comparing home loans with low interest rates or fees, as with the head to head comparison technique, product comparison component 212 compares loans first based on their monthly payment and then by any other relevant product feature (such as interest rate). Similarly, if the client needs an auto insurance policy with higher liability coverage than their current policy, product comparison component 212 may select a policy with higher liability coverage, even though the policy may have a higher premium.

Product comparison component 212 may also use an “expected cost” comparison technique. In the expected costs comparison, the product comparison component 212 calculates the expected cost of each financial product. The expected cost takes into account a variety of factors, the expected timeframe of usage, the expected type of usage (pay only the minimum payment every month on time), and all costs associated with using a product (including the interest rate, fees, and switching costs). Product comparison components 212 uses one or more of these factors, as well as any other useful factors, to determine an expected cost for each financial product. Product comparison component 212 can select the financial product with the lowest expected cost.

Product comparison component 212 may use any of the previous techniques to compare financial products. Product comparison component 212 may also use any other comparison techniques, alone or in combination, to compare financial products. The product comparison component 212 may take into account multiple factors when comparing financial products. For example, instead of merely comparing loans based solely on interest rate alone, product comparison component 212 can compare loans based on interest rate, monthly payment, fixed costs, and expected payment over a fixed period of time.

Regardless of what technique product comparison component utilizes, product comparison component 212 may perform at least two levels of comparison. On one level, the product comparison component compares new financial products received from the communication component 208 between themselves. On the second level, product comparison component 212 also compares the new financial products with the client 100's existing financial product, if the client 100 has an existing financial product. If the client is looking to replace an existing product, the product comparison component 212 will also compare the new financial product with the client's existing product, selecting only financial products superior to the client's existing financial product.

After product comparison component 212 compares financial products, if the component determines that one (or more) products are a better match for client 100 than client 100's existing product (if any), the product comparison component 212 transmits information about those products to client 100 via client interface 216, subject to client system preferences 206e. If the client is shopping around for a new financial product and is not looking to replace an existing financial product, product comparison component 212 may instead present all of the financial products to the client with a rank ordering based on the most suitable comparison method.

System preferences 206e may include communication preferences and approval preferences. Communication preferences specify how the client wishes to be contacted, the frequency of communication, and the priority of communication. The client may specify how he wants to receive financial product information, such as via E-mail, text message, telephone, or via the mail. The client can specify the frequency of communication. For example, the client could create a weekly schedule of communication. The product comparison component 212 would then communicate financial products to the client 100 once a week. Frequency may also be determined by specified criteria (such as a minimum level of savings over the client's current financial product). If the product comparison component 212 finds a financial product meeting the criteria, only then would the product comparison component 212 transmit information to the client 100. The client could also specify a particular priority. For example, the client could specify that he only wishes to receive information about financial products that save more than $100 per year. The client could specify that high-priority information should be transmitted via E-mail, but low-priority information (such as products which would not result in significant savings) should be sent via conventional postal mail.

System preferences 206e may also include approval preferences. Approval preferences specify when the financial product system 102 should wait for the client's approval before transferring the client to a recommended financial product. In certain situations, the client may want the system to automatically transfer the client to a recommended financial product without waiting for the client to approve the transfer. For example, the client may, in the approval preferences, instruct the financial product system 102 to automatically transfer the client to a car insurance policy that will save the client more than $100 per year. If the financial product system 102 finds a car insurance policy meeting the criteria, the financial product system will automatically transfer the client to the new policy. The client will be informed of the transfer pursuant to the communication preferences. System preferences include these preferences as well as any other preferences regarding the system's operation with respect to the client.

In addition to transmitting information about financial products, product comparison component 212 may also transmit other information or provide the client 100 with access to other information about financial products. This information may include customer ratings of financial products and independent reviews. Providing this information may assist the client in coming to a decision about which financial product to select (if any).

Once client 100 receives the financial product information, (if client has specified that he wishes to receive financial product information) client 100 may then examine the products at his own leisure. If client 100 wants more information about a product, client 100 may request information from the financial product system 102 via client interface 216. Financial product system can transmit the requested information either by retrieving it from data warehouse 202 or by obtaining it from financial institutions. Once client 100 chooses a financial product to replace an existing product, transfer facilitation component 214 provides assistance to the client in switching from an existing financial product (if any) to the new financial product. If the client does not have an existing financial product, the transfer process is optional.

Both product comparison component 212 and transfer facilitation component 214 may record information back into data warehouse 202 so that data warehouse 202 will always have the most up-to-date information. This information may include the client's new financial product, the financial product information transmitted to the client, which financial product the client selected (if any), the outcome of the transfer, and whether the client failed to complete the process. The information may be any information obtained through the operation of the financial product system 102.

The embodiment shown in FIG. 2 is one exemplary embodiment of the present invention. Other embodiments may be used without departing from the scope of the present invention. One or more of the components shown in FIG. 2 could comprise sub-components of a larger component. For example, client data collection component 210 and communication component 208 could be sub-components of data warehouse 202. Similarly, the components shown in FIG. 1 could comprise multiple sub-components. Thus, communication component 208 may comprise a sub-component for communicating with data warehouse component 202 and another component to communicate with decisionmaking components 204a and 204b. Any arrangement of components is possible without departing from the scope of the present invention.

FIG. 2 shows a logical arrangement of components according to the present invention. Any physical arrangement of the components may be used without departing from the scope of the present invention. Generally, the components may be arranged in any fashion depending on the needs of the entity using the present invention. For example, data warehouse component 202, communication component 208, and client data collection component 210 may be located on one server. Product comparison component 212 may be located on another server and transfer facilitation component 214 on a third server. The components would communicate with each other through a network. In another arrangement, the components are replicated across multiple servers in a network to reduce the load on the individual servers. Other configurations are also possible and within the scope of the present invention.

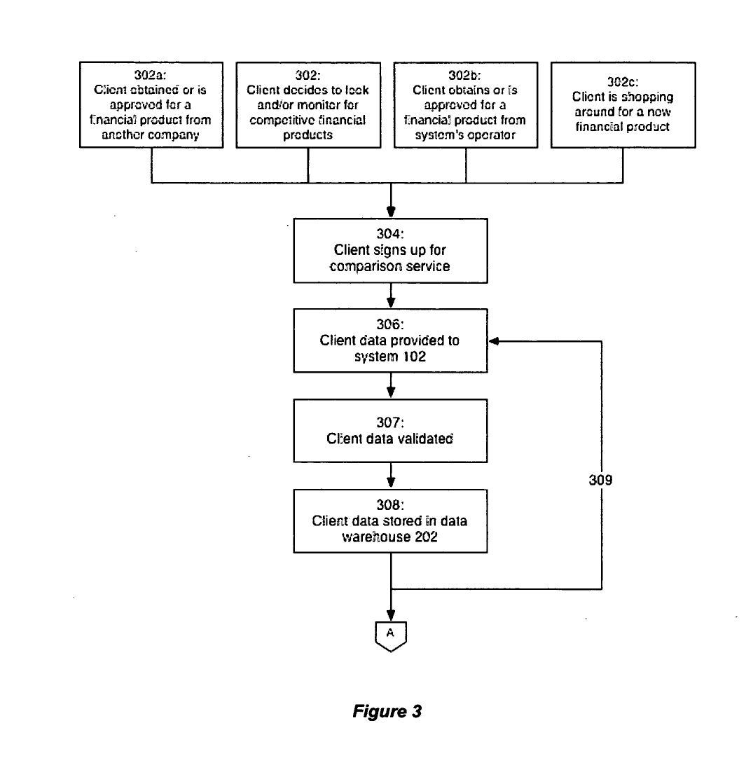

FIGS. 3, 4, and 5 show an exemplary method of performing the present invention. The method may begin in any number of ways. FIG. 3 shows several possible starting points. In step 302a, the client 100 has obtained a financial product from another company. Here the client 100 may be using the system to see if better offers are now available. In step 302b, the client obtains (or is approved for) a financial product with the company operating the present invention. The company could offer the present invention as an added benefit to its clients. In step 302c, the client is actively looking to get a new financial product (shopping around). For example, the client could be considering the purchase of a new home sometime within the next couple of months and would like to determine the best mortgage offers he or she qualifies for. The client could be looking for financial products for any reason, as shown in step 302.

One or more steps of the method shown in FIGS. 3, 4, and 5 may be performed in real-time. For example, the client may be shopping around for a new financial product, as shown in step 302c. While the client is interacting with the present system, the other method steps are performed and the client is presented with results right away.

Alternatively, one or more steps of the method may be performed separately in time from one another. For example, the client may have obtained a financial product (shown in step 302a) several months prior to signing up with the service in step 304. Similarly, several of the method steps may be repeated over the course of time, as shown by arrow 309.

The client then signs up for the service offered by the present invention in step 304. The client could sign up in a number of ways. For example, the present invention could be offered by an automobile dealership as a way to secure the best automobile loan for its customers. The client could sign up for the service, or the automobile dealership could sign the client with the service with the client's permission. The service could also be offered by a third party. The client learns about the service and visits the third party's web site and signs up via the web site. If the client has obtained a financial product from the system's operators (step 302b), the client may be automatically signed up for the service.

The system then collects client information in step 306. The system can collect client information using any of the techniques described above, such as collecting information from the client, collecting information from a third party, or receiving information from a third party. The client information is validated in step 307 to make sure that the client has entered all the necessary information correctly. Once validated, the client information is stored in a data warehouse (step 308).

The method ensures that the client information stored in the data warehouse is continually kept up to date by repeating steps 306-308. The repetition may be accomplished in a number of ways. The client could log in to the system and provide updated information. The system could pull updated information from a client's account with a financial institution (with the client's permission). The system could update the information received from a third party. If the system obtains a credit report, this would, in most cases, show up in the credit report as a “monitoring inquiry”. In this fashion the client's credit is not damaged through repeated “credit inquiries”.

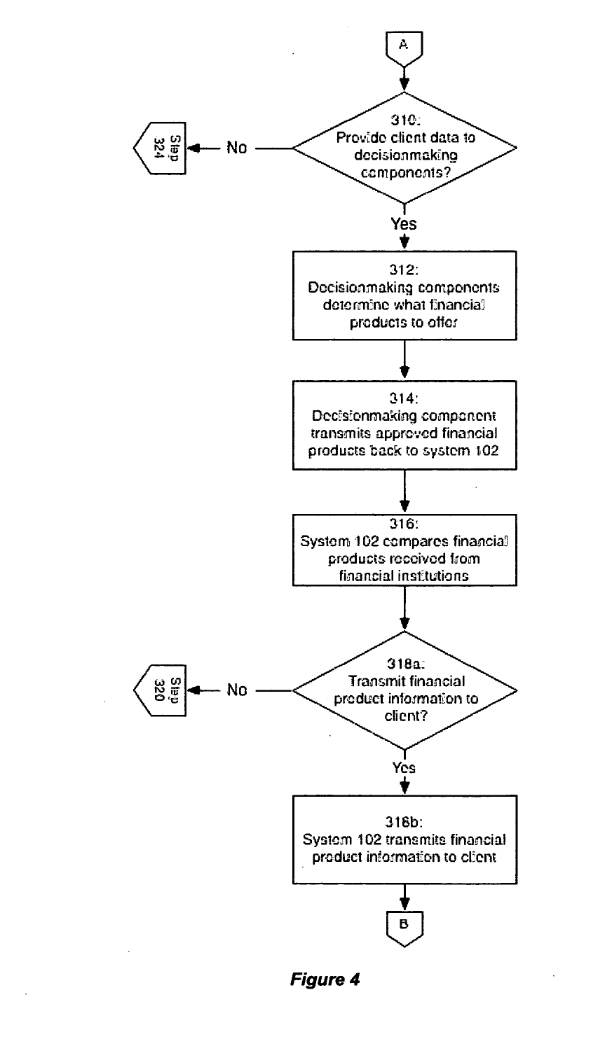

The exemplary method continues in FIG. 4 with step 310, where the system determines whether to transmit client information to decisionmaking components. Financial product system may use a filter to determine what information to send, when to send the information, and where to send the information. Thus, financial product system will not send information about client 100's home to decisionmaking components when the client is looking for competitive automobile loans. Similarly, the financial product system will not send client information to decisionmaking components if the system determines, for any reason, that the client cannot receive a competitive financial product from the decisionmaking component. If the system does not transmit client information, the method proceeds to step 324; otherwise, the method proceeds to step 312.

These decisionmaking components are equipped to determine for which financial products, offered by one or more particular financial institutions, the clients are eligible. The entity offering the system may also have its own decisionmaking components for its own financial products. In step 312, the various decisionmaking components evaluate the client information they have received and determine for which (if any) financial products the client qualifies for. The decisionmaking components will evaluate the client based on a number of criteria, such as the client information it received in step 310, the financial institution's own guidelines for evaluating clients, and information acquired from other sources, such as the public domain. The decisionmaking component can use any of these criteria as well as other criteria for evaluating clients and determining which products the client qualifies for. After evaluating the client, the decisionmaking components transmit the financial products for which the client is qualified back to the system in step 314.

After the system receives financial product information from the decisionmaking components, in step 316 the system comprehensively compares the various products as well as the product client 100 currently has, if any. The system may use any comparison technique such as the head to head, needs-based, expected cost techniques, or others, as described earlier. The system compares products not only between the new products it has received but also between the new products and the client's existing product, if any (two levels of comparison).

Based on the results of the product comparison and the client's preferences, the system determines whether to transmit information about the product to the client in step 318a. The client can specify how the system should transmit the information (using phone, e-mail, etc.), when the system should transmit the information (including whether or not the system should transmit the information at all), and whether, based on priority, the system should transmit the information in a different manner (e.g., send mobile phone text message instead of postal mail). If the system decides not to transmit the information, the method proceeds to step 320. Otherwise, the system transmits the information about the recommended financial product to the client in step 318b.

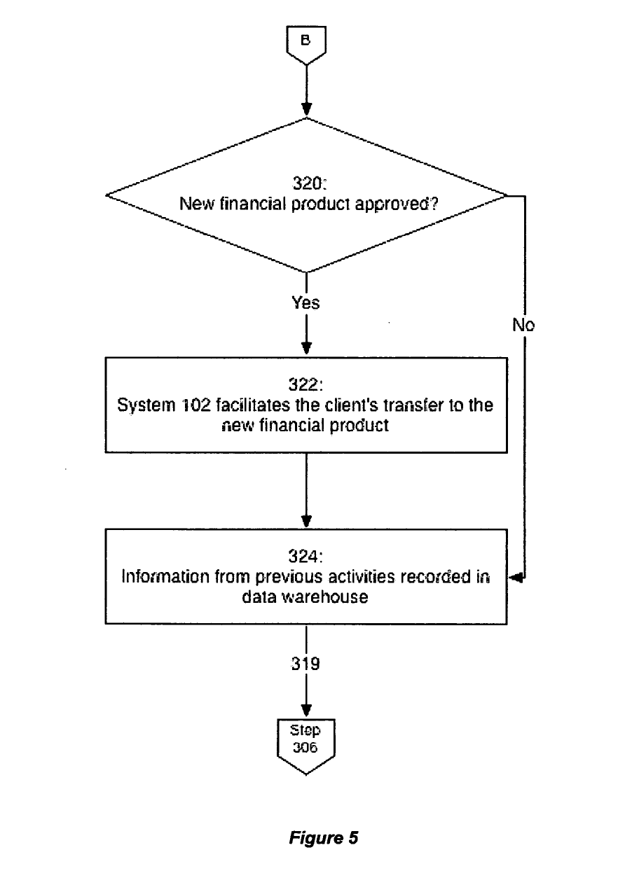

As shown by FIG. 5, in step 320 the recommended financial products are examined and approval is (or is not) given to transfer the client to one of the financial products. The client may specify whether the approval step should be performed by the client or by the system and the criteria by which the system may approve a product on the client's behalf. Exemplary criteria might be a new financial product which would result in significant yearly savings (such as $1000) over the client's existing product. Once a new product is approved, whether by the client or by the system, the method continues with step 322, in which the system assists the client in obtaining the new financial product. If the client does not select a new product, the method skips to step 324.

The process of transferring the client from an existing financial product to a new financial product as shown by step 322 may occur in a number of ways, depending on the type of product. The system may employ a number of techniques to simplify the process and cut costs.

If the financial product is a mortgage or a home equity line of credit (HELOC), the system may use at least two techniques to simplify the transfer and reduce costs. In one technique, the new lender buys the existing loan from the previous lender. Once the sale is concluded, the new lender adjusts the terms and conditions of the loan to match the new terms and conditions. The mortgage deed is assigned to the new lender and the terms adjusted accordingly. Depending on the amount of the mortgage, this technique may reduce or eliminate the need (or cost) of appraisal, title insurance, releasing the original mortgage, recording a new mortgage (including the payment of any taxes), and closing costs.

Another technique involves the use of a third party. The original lender registers its deed using a third party, possibly the operator of the present invention. The third party keeps track of the lender responsible for the loan. When the client changes to a new loan, the third party changes the lender from the old lender to the new lender. The new lender then adjusts the terms and conditions of the loan accordingly, as with the first technique above. This reduces the costs associated with the transfer and eliminates the need for one lender to sell the loan to the other.

For savings products, such as certificates of deposits or savings accounts, the system can simplify the process by accepting the client's funds itself. The system then opens the account on the client's behalf and deposits the funds into the new account. The system could also maintain a plurality of accounts with financial institutions and move the client's money between these existing accounts.

In the case of credit cards and debit cards, the system may assist the client by arranging the issuance of the new credit card account, including transfer of pending balances, and closing the old credit card account. The system could also issue a card linked to the new credit or debit card account; if the client later changes to a different account, the system changes the account to which the card is linked without requiring the client to change the card they are using.

The system could also link a credit card issued by the system to multiple credit card accounts and charge the different accounts depending on the nature of the charge. For example, Credit card Company A may offer 1.5% cash back on all purchases. Credit Card Company B may offer 5% cash back on gasoline purchases. The system issues the client 100 a credit card linked to both accounts. When the client purchases gas, the system assigns the charge to the Company B account, which has 5% cash back. For all other purchases, the system assigns the charge to the Company A account. In this fashion the system maximizes the client's cash back. The same techniques used for credit cards may also be used for debit cards.

Finally, the method concludes with step 324, where any information from the previous activities is recorded in the data warehouse. This information can be any information about the transaction, such as the financial products presented to the client, which financial product (if any) the client approved, the outcome of the transfer process, and whether or not the client abandoned the process at any point. If, for example, the client selects a new financial product, the new financial product may be recorded in the data warehouse as the client's now-current financial product, replacing the previous financial product.

As shown by arrow 319, the method repeats steps 306-324. The repetition could occur based on a predetermined schedule (daily, weekly, monthly), based on changing market conditions (an interest rate reduction), based on the request of the client, based on changes on the client's financial situation, or based on any combination of these or other factors. Continually querying decisionmaking components with client information permits the system to offer the client competitive products as the market and the client's situation change. For example, the interest rate on an automobile loan in September may be 6%. However, in October the interest rate may drop to 5%, perhaps due to market conditions or the client's improved credit score. Through repeated querying the system will pick up on the improved interest rate and offer the client a loan with the reduced rate in October. In this fashion the client is assured of having the best loan terms without having to continually research the market. This comparison is merely exemplary; the system can compare products using multiple factors in addition to an interest rate, such as expected monthly payment, expected total payment over a period of time, fixed costs or others. The factors taken into account would vary depending on the type of financial product being compared.

In the method previously described, steps 306-308 and 306-324 are repeated, as shown by arrows 309 and 319 respectively. However, any of the steps may be repeated in order to provide the client 100 with the best available financial products. Continually updating client information and querying for competitive products permits the system to offer the client a dynamic picture of the products available to him. The client no longer needs to suffer “buyer's remorse” or worry about the possibility of a new, more competitive product he did not know about or have access to. The present invention insures that the client will always receive the best deal available in the easiest way.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for regularly comparing and obtaining financial product information comprising a plurality of components stored on computer-readable media, the system comprising:
a client interface component;
a data warehouse component capable of storing information;
a client data collection component capable of collecting information about said client and storing the data in the data warehouse component;
a decisionmaking component capable of receiving client information and transmitting financial product information based on said client information;
a communication component capable of communicating client information stored in the data warehouse component to a the decisionmaking component and receiving financial product information from the decisionmaking component;
a product comparison component capable of comparing a plurality of financial product information received by said communication component and transmitting a subset of said plurality of financial product information to said client via the client interface component based on said comparison; and
a transfer facilitation component capable of facilitating the client's transfer from one financial product to another financial product selected from said subset.

2. The system of claim 1, wherein the financial product comprises one of lending products, insurance products, savings products, and investment products.

3. The system of claim 1, wherein the client data collection component collects data from the client via the client interface component.

4. The system of claim 1, wherein the client data collection component collects data from third parties.

5. The system of claim 1, wherein the product comparison component compares financial products by performing a head to head price comparison.

6. The system of claim 1, wherein the product comparison component compares financial products based on the client's needs.

7. The system of claim 1, further comprises a filter component capable of instructing the communication component when to transmit client information, where to transmit client information, and what client information to transmit.

8. The system of claim 7, wherein the filter component instructs the communication component to transmit client information based on said client information and optionally predefined criteria.

9. The system of claim 1, wherein the communication component stores said plurality of financial product information in said data warehouse.

10. The system of claim 1, further comprising a validation component capable of validating information collected by the client data collection component.

11. The system of claim 1, wherein the product comparison component transmits said subset based on preferences contained in the client information.

12. The system of claim 1, wherein the product comparison component compares financial products based on expected cost.

13. The system of claim 1, wherein the transfer facilitation component is capable of automatically transferring a client to a new financial product based on predetermined criteria.

14. A system for regularly comparing and switching financial products comprising a plurality of components stored on computer readable media, the system comprising:
a client interface component;
a data warehouse component capable of storing client information;
a client data collection component capable of collecting client information and storing the client information in said data warehouse component;
a communication component for communicating client information to a decisionmaking component and receiving financial product information from a decisionmaking component;
a product comparison component capable of comparing a plurality of financial products received by said communication component and transmitting to a client a subset of said plurality of financial products via the client interface component; and
a transfer facilitation component capable of facilitating the client's transfer from an existing financial product to a financial product in said subset.

15. The system of claim 14, wherein the financial product comprises one of lending products, insurance products, savings products, or investment products.

16. The system of claim 14, wherein the financial products are credit card or debit card products and the transfer facilitation component is capable of issuing a client a card linked to a credit or debit card product and is capable of changing what credit card or debit card product is linked to said card.

17. The system of claim 16, wherein said card is linked to a plurality of credit card or debit card products.

18. The system of claim 16, wherein allocation of charges between the plurality of credit card or debit card products is performed in the most efficient fashion.

19. The system of claim 14, wherein the financial product is a loan and the transfer facilitation component is capable of selling the client's existing loan to the provider of a new loan product from said subset.

20. The system of claim 14, wherein the financial product is a loan product and the transfer facilitation component is further capable of transferring the client's financial products to a new loan product from said subset using a deed registered to a third party.

21. The system of claim 14, wherein the financial product is a savings product and the transfer facilitation component facilitates transfer by opening a new savings product on the client's behalf and transferring to the new savings product money the client has deposited.

22. The system of claim 14, wherein the financial product is a savings product and the transfer facilitation component facilitates transfer by maintaining a plurality of savings products, one of which is the financial product in said subset, and transferring to the financial product in said subset money the client has deposited.

23. A method for regularly comparing financial products, comprising the steps of:
collecting client information;
storing client information in a data warehouse;
communicating client information to decisionmaking components;
receiving financial product information for a client from decisionmaking components;
comparing a plurality of financial products received from decisionmaking components;
transmitting a subset of said plurality of financial products to the client based on the results of the comparison step; and
performing at least one of the steps on a regular basis.

24. The method of claim 23, wherein financial products are one of lending products, insurance products, savings products, or investment products.

25. The method of claim 23, further comprising the step of the decisionmaking components determining whether to offer a financial product and under what terms based on the client information transmitted to the decisionmaking components.

26. The method of claim 23, wherein the communication step communicates client information on a regular basis based on a predetermined schedule.

27. The method of claim 23, wherein the communication step communicates client information on a regular-basis is determined by the client and optionally predetermined criteria.

28. The method of claim 23, further comprising the step of validating client information.

29. The method of claim 23, wherein the transmitting step transmits client information based on the client information.

30. The method of claim 23, wherein the comparison step compares financial products using a head to head price comparison.

31. The method of claim 23, wherein the comparison step compares financial products based on the client's needs.

32. The method of claim 23, wherein the comparison step compares financial products based on an expected cost.

33. The method of claim 23, further comprising the step of facilitating the client's transfer from an existing financial product to a new financial product selected from said subset.

34. The method of claim 31, wherein the facilitating step automatically transfers the client to a new financial product based on predetermined criteria.

35. The method of claim 23, further comprising the step of recording information generated by any other step into the data warehouse.
